(19) United States
(12) Patent Application Publication
(10) Pub. No.: US 2025/0155056 A1
(43) Pub. Date: May 15, 2025

(54) A THREADED PIPE CONNECTION

(71) Applicant: TENARIS CONNECTIONS B.V., Amsterdam (NL)

(72) Inventors: Juan Manuel ARINA, Buenos Aires (AR); Martin DURRUTY, Katy, TX (US); José Daniel MOLINA, Buenos Aires (AR)

(21) Appl. No.: 18/730,273

(22) PCT Filed: Jan. 18, 2023
(86) PCT No.: PCT/EP2023/051151

§ 371 Date: Jul. 18, 2024

(30) Foreign Application Priority Data
Jan. 19, 2022 (EP) 22152289.9

(51) Int. Cl. F16L 15/00; E21B 17/042

(52) U.S. Cl. CPC F16L 15/002; E21B 17/0423

(57) ABSTRACT

The present invention relates to a threaded pipe connection. A threaded pipe connection comprising a tubular coupling with first and second female threaded zones formed in opposing sections; and first and second pipes, each comprising a male threaded zone and a shoulder surface at its terminal end, wherein each female threaded zone includes a female thread that tapers radially within the female threaded zone from a maximum diameter at the outer end of the female threaded zone, wherein each male threaded zone includes a male thread that tapers radially so as to reduce in diameter towards the terminal end of the pipe, wherein the threaded pipe connection is configured to enable the first and second pipes to be engaged with the tubular coupling in a made-up configuration in which: the shoulder surfaces of the first and second pipes abut; the entire male threaded zone of the first pipe engages the entire first female threaded zone; the entire male threaded zone of the second pipe engages the entire second female threaded zone; and for each of the first and second female threaded zones. The crest of one of the male and female threads radially interferes with the root of the other of the male and female threads in a first portion of the female threaded zone and does not interfere or interferes by a smaller amount in a second portion of the female threaded zone; the second portion is located at the inner end of the female threaded zone.

The present invention relates to a threaded pipe connection. Specifically, the threaded pipe connection is of the type in which a tubular coupling having a box at either end is used to provide a connection between the ends of two pipes, each terminating in a pin that engages a respective box with the terminal ends of the pins abutting in the made-up configuration of the threaded pipe connection. Such pipe connections are known in the field of natural gas and oil extraction.

With connections of the type in which two opposing pins abut within a tubular coupling, the elasticity of the pins results in desired axial compression along with associated radial expansion. However, as discussed below, the inventors have recognised that a problem with such connections is that the pin may also deform radially inwardly at its terminal end. Radially inward deformation may form a limitation for a so-called drift to pass the connection during a quality check. Such limitation may lead to extra operational costs. In particular, the drift may get stuck, wherein the connection can be damaged. In such cases, the connection needs to be pulled from the pipe string, wherein the interior of the connection needs to be repaired or re-machined (in situ) before operations can proceed.

According to the invention, there is provided a threaded pipe connection that can reduce or avoid some or all of these problems.

The threaded connection comprises a tubular coupling with first and second female threaded zones formed in opposing halves of its internal surface, and first and second pipes.

Preferably, the shoulder surfaces lies on a plane extending perpendicular to the longitudinal axis of the pipes.

The first and second female threaded zones may be formed in opposing ends of the coupling, the ends being sections of the couplings for engagement with the pipes. That is, they may extend from at or near the extreme ends of the tubular coupling to at or near the middle of the coupling.

Each of the pipes comprises a male threaded zone on its external surface and a shoulder surface at its terminal end for abutment with the shoulder surface of another pipe. Each male threaded zone includes a male thread, preferably a trapezoidal thread, that tapers radially so as to reduce in diameter towards the terminal end of the pipe.

The male and female threaded zones may each be defined by the entirety of a thread, or they may be zones of a respective thread. For example, the thread extending through the zone may continue beyond the ends of the zone.

Each female threaded zone may extend from an inner end to an outer end, wherein the inner end of each threaded zone is the end nearest the centre of the tubular coupling. Each female threaded zone includes a female thread, preferably a trapezoidal thread, that tapers radially within the female threaded zone from a maximum diameter at the outer end of the female threaded zone to a minimum diameter at the inner end of the female threaded zone. For each of the female threaded zones, the outer end of the female threaded zone is closer to the end of the coupling than the inner end of the female threaded zone. For each of the female threaded zones, the inner end is opposite the outer end.

As noted above, the preferable thread form for both male and female threads is a trapezoidal thread. As is known in the art, a trapezoidal thread includes a root, a crest, a stabbing flank and a load flank. For a single thread, its root, crest, and flanks extend helically to define turns of the thread about the pipe or within the coupling. In the field, the neighbouring turns of a crest are often referred to as crests because they appear discrete in cross-section. However, the crests are simply spaced apart sections of a single helical crest.

The threaded pipe connection is configured to enable the first and second pipes to be engaged with the coupling in a made-up configuration. In the made-up configuration the shoulder surfaces of the first and second pipes abut and the threaded zones of the pipes engage the threaded zones of the tubular coupling.

In each of the first and second female threaded zones, the crest of one of the male and female threads radially interferes with the root of the other of the male and female threads in a first portion of the female threaded zone. In a second portion of the female threaded zone there is either a clearance, no interference, or less interference than in the first portion. In particular, in the second portion of the female threaded zone there may be either a radial clearance, no radial interference, or less radial interference than in the first portion. In some embodiments, there is no radial interference at all and there may even be a clearance in the second portion.

As is well known to the Skilled Person, radial interference occurs when the male member has a larger radius than the female member into which it is fitted at the point of contact.

That is, in some cases:
the crest of the male thread radially interferes with the root of female thread in the first portion of the female threaded zone by a greater amount than in the second portion of the female threaded zone; and/or
the crest of the female thread radially interferes with the root of the male thread in the first portion of the female threaded zone by a greater amount than in the second portion of the female threaded zone.

In some cases:
the crest of the male thread radially interferes with the root of female thread in the first portion of the female threaded zone and the crest of the male thread does not radially interfere (e.g., there is a clearance) with the root of female thread in the second portion of the female threaded zone; and/or
the crest of the female thread radially interferes with the root of the male thread in the first portion of the female threaded zone and the crest of the female thread does not radially interfere (e.g., there is a clearance) with the root of male thread in the second portion of the female threaded zone.

Preferably, there is a clearance between the root of the one of the male and female threads and the crest of the other of the male and female threads in the second portion of the female threaded zone.

The second portion is located at the inner end of the respective female threaded zone. The axial length of the second portion of the female threaded zone may be at least 4 turns. The axial length of the second portion of the female threaded zone may be at least 20 mm.

By reducing or avoiding interference in the second portion, which is at the inner end of both of the female threaded zones, the interference between the male and female threads is reduced or avoided at the middle of the connection in the region of the engagement between the shoulders of the two pipes.

One way of achieving the reduction in (or avoidance of) interference is by reducing the height of the thread to reduce the force with which the crest radially interferes with the opposing root. For example, the first portion may be a complete portion in which the height of the thread is constant (i.e., there is a fixed radial distance between crest and root); and the second portion may be an incomplete portion in which the height of the thread is less than in the complete portion.

The inventors have recognised that the problem of inward deformation of the terminal ends of the pipes can be reduced, or avoided, by the reduction of (or avoidance of) thread interference in this region.

For example, in each of the first and second female threaded zones, the crest of the male thread may radially interfere with the root of the female thread in the first portion of the female threaded zone by a greater amount than in the second portion of the female threaded zone. In both the first and second portion of each of the first and second female threaded zones, there may be a clearance between the root of the male thread and the crest of the female thread.

In an alternative example, in each of the first and second female threaded zones, the crest of the female thread may radially interfere with the root of the male thread in the first portion of the female threaded zone by a greater amount than in the second portion of the female threaded zone. In both the first and second portion of each of the first and second female threaded zones, there may be a clearance between the crest of the male thread and the root of the female thread.

In preferred embodiments, the first portion is a complete portion in which the height of the female thread (the distance in the radial direction between crest and root) is constant; and the second portion is an incomplete portion in which the height of the female thread is less than in the complete portion. In such embodiments, the crest of the female thread throughout the complete portion of the female threaded zone is arranged to contact the root of the male thread of a male threaded zone.

A method of manufacturing the tubular coupling for a threaded pipe connection comprises providing a tubular coupling having first and second tapered threaded zones with adjacent end portions, in particular with adjacent inner end portions. Each tapered threaded zone may extend from an inner end to an outer end. The inner end of each threaded zone is the end nearest the centre of the tubular coupling. The method further comprises reducing the height of the threads of the adjacent, particularly inner, end portions of each the first and second tapered threaded zones.

Although not essential, a preferred way to form the incomplete portion is by forming the crest of the female thread to define a cylindrical surface. The cylindrical surface is therefore at the inner end of each female thread, i.e. the end of the female thread closest to the middle of the connection.

In other words, the crest of the female thread within each female threaded zone may define a cylindrical surface at the inner end of the female threaded zone.

Indeed, the cylindrical surface may be machined in a single operation, either before or after cutting the threads. In that way, the crests of the female threads of both female threaded zones may define a common cylindrical surface at the inner end of the female threaded zone.

The threaded pipe connection set out above, with or without the optional features, preferably involves engagement between the tubular coupling and the pipes only via threaded engagement (e.g., in the threaded zones) when the connection is made-up. Therefore, in contrast to many other connections of this type, in the made-up configuration the first and second pipes do not contact the tubular coupling between the male threaded zones of the first and second pipes. That is, in the made-up configuration the first and second pipes are free from contact with the tubular coupling between the male threaded zones of the first and second pipes.

Although some sealing is achieved via the axial abutment between the pipes, the inventors have realised that further sealing is preferably achieved by the threads. Accordingly, the maximum clearance between the engaged threads is preferably no more than 0.18 mm. The clearance is measured between the opposing crests, roots, and flanks of the threads.

The make-up torque required by the connection is achieved by the axial abutment of the ends of the two opposing pipes screwed into the tubular coupling. As a result, there is no need for the tubular coupling to include a shoulder surface. In other words, the tubular coupling may be free of a shoulder surface. In particular, there is no need for the tubular coupling to include a shoulder surface between the first and second female threaded zones for abutment with the pipes.

A threaded pipe connection formed as set out above can advantageously be manufactured more easily than conventional couplings of this type, since there is no need for highly accurate sealing surfaces (often referred to as a metal-to-metal seal) or abutment surfaces to be formed in the tubular coupling. The presence of sealing surface on the pipes and tubular coupling would occupy significant radial and axial extents of the pipe and tubular coupling.

The absence of such a dedicated seal can therefore enable a larger radial extent for the threads or, conversely, a reduction in thickness of the tubular coupling and pipes. Similarly, the absence of such a dedicated seal can enable a larger proportion of the radial dimension of the pipes to be used as shoulders, thus providing additional shouldering torque capacity.

In the axial sense, the absence of the seal can allow the tubular coupling to be shorter, or the threads to occupy a larger proportion of the tubular coupling.

By providing the reduction in height of the female threads towards the inner ends thereof, preferably by forming the crests in the middle region of the tubular coupling so that they collectively define a cylindrical surface. the female threads occupy less space, in particular in the radial direction, around the location of abutment of the first and second pipes, such that there is more room for the first and second pipes.

As mentioned above, the threads are tapered. That is, the female threads each taper within the respective female threaded zone by a first angle relative to the longitudinal axis of the tubular coupling, and each male thread tapers radially within the male threaded zone by a second angle relative to the longitudinal axis of the respective pipe. The reduction in height of the female threads, can accommodate the use of converging thread tapers.

Accordingly, in preferred embodiments, the first angle is greater than the second angle. Since the first angle is greater than the second angle, the threads converge toward the terminal end of the respective pin. In such embodiments, the hoop stresses in the tubular coupling at the outermost ends of the female threaded zones (i.e. towards the terminal ends of the tubular coupling) can be reduced as compared with parallel male and female thread tapers. This is particularly important in some applications, since the hydrocarbons in the environment can make the ends of the tubular coupling brittle. As the first angle is greater than the second angle, hoop stresses at the outermost ends of the female threaded zones can be kept relatively small. As such, the connection can be less susceptible to cracks in the material of the coupling at the outermost ends of the tubular coupling as a result of high hoop stresses. Moreover, incomplete threads can be more prone to galling than complete threads, owing to their smaller flanks and sharper corners, by reducing or eliminating radial interference, such galling problems can be lessened or avoided.

The use of converging tapers allows the taper of the male thread (the second angle) to be reduced. This, in turn, reduces the radial extent of the male threaded zone, which therefore enables the pipe end shoulders to have greater radial dimension (just like the absence of a seal). Such shoulders can therefore withstand greater torque, and so deflect less under compression.

In some applications, it is important for speed and accuracy to improve the stabbing capability of the connection. Also to improve stabbing, the radially outer edge of the shoulder at the ends of the pipes may be bevelled. Optionally, a bevel may be provided on the male and/or female threads where the crest meets the stabbing flank.

The male and female threads may each comprise a crest, a root, a stabbing flank and a load flank. Although various trapezoidal thread forms may be used for the connection described above, a buttress type thread is preferred. At make-up, when the pipe shoulder surfaces abut, the load flanks of male and female threads contact, the crest of a first of the threads contacts the root of the second of the threads, with a clearance between the root of the first thread and the crest of the second thread, and a clearance between stabbing flanks.

For a better understanding of the invention, and to show how the same may be put into effect, reference will now be made, by way of example only, to the accompanying drawings in which:

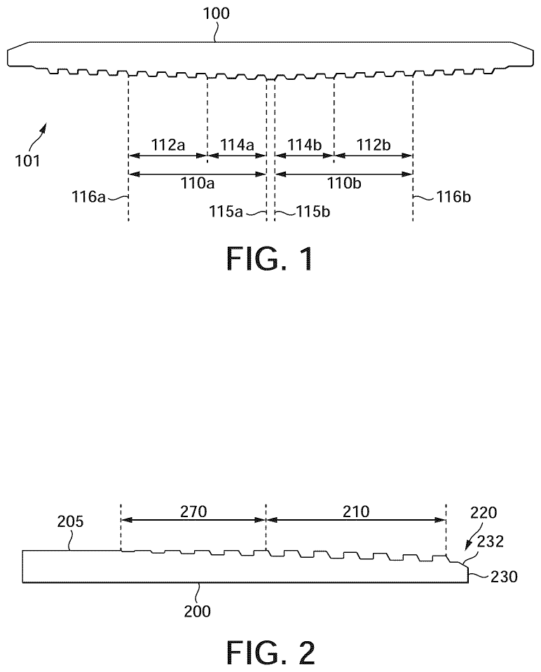

FIG. 1 shows a half-cross-section of a tubular coupling forming part of a first embodiment of a threaded pipe connection in accordance with the invention;

FIG. 2 shows a half-cross-section of a first pipe forming part of the first embodiment of a threaded pipe connection in accordance with the invention;

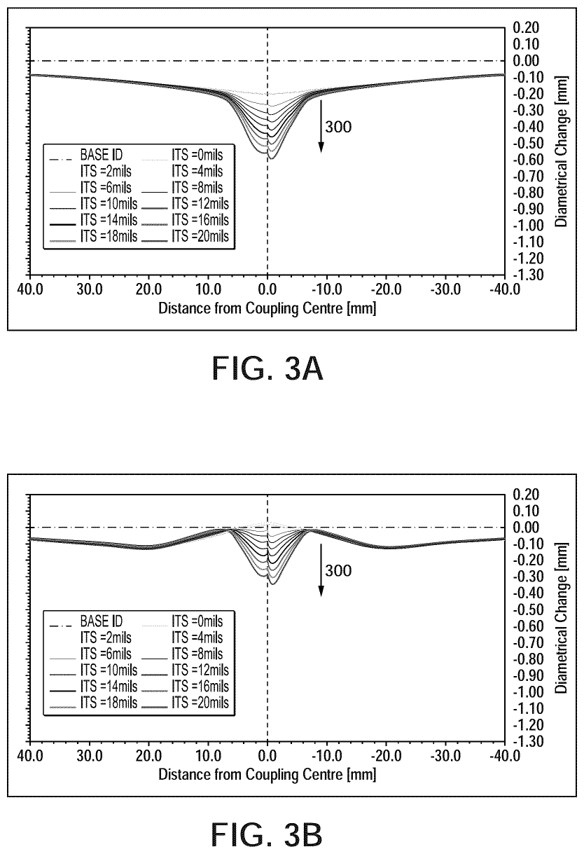

FIG. 3a shows the effect of torque on the deflection of pipe ends in a comparative example of the prior art;

FIG. 3b shows the effect of torque on deflection of pipe ends in the first embodiment of the present invention; and

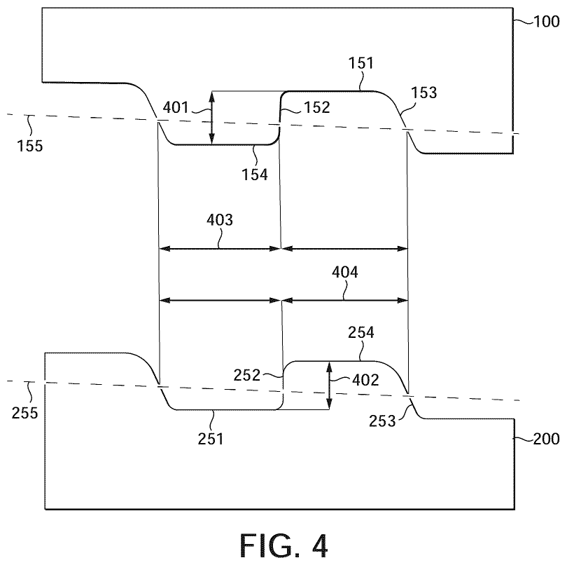

FIG. 4 shows a cross-section of a preferred thread form for use with the first embodiment.

As shown in FIGS. 1 and 2, a first embodiment of the invention is a first threaded pipe connection comprising a tubular coupling 100 and first and second pipes 200. The second pipe 200 is identical to the first pipe 200.

The tubular coupling 100 is shown in FIG. 1. The tubular coupling 100 is a generally tubular body with an internal surface 101. A first female threaded zone 110a is formed in the one half of the internal surface 101 and a second female threaded zone 110b is formed in the opposite half of the internal surface 101. The female threaded zones 110a, 110b each extend from an inner end 115a, 115b to an outer end 116a, 116b. The inner end 115a, 115b of each threaded zone 110a, 110b is that nearest the centre of the tubular coupling 100. The outer end 116a, 116b of each threaded zone 110a, 110b is that nearest the end of the tubular coupling 100 closest to that zone. The first and second female threaded zones 110a, 110b may be zones along respective separate female threads.

The centre of the tubular coupling 100 may be at, or approximately at, the mid-point of the tubular coupling 100 in the axial direction. The centre of the tubular coupling 100 may be located between the female threaded zones 110a, 110b. The centre of the tubular coupling 100 may be an axial location along the longitudinal axis of the coupling.

As can be seen in FIG. 2, the male thread may include a male runout 270 in addition to, or as part of, the male threaded zone 210. Optionally, the female thread may include a runout. The runouts may form part of the threaded zones, or be outside the threaded zones.

Each female threaded zone 110a, 110b includes a trapezoidal female thread (described in more detail below) that tapers radially within the female threaded zone from a maximum diameter at the outer end 116a, 116b of the female threaded zone 110a.

As can be seen from FIG. 1, the tubular coupling 100 does not comprise a shoulder surface between the first and second female threaded zones (that is, it is free of shoulder surfaces). In fact, it is preferred that, as shown, the tubular coupling 100 does not include any shoulder surface arranged to abut with one of the pipes 200 (that is, it is free of shoulder surfaces arranged to abut with one of the pipes 200).

Furthermore, the tubular coupling 100 does not comprise any surfaces other than that of the thread designed to seal by interference with surfaces on the pipes 200 (that is, it is free of any surfaces other than that of the thread designed to seal by interference with surfaces on the pipes 200). That is, there is no conventional conical or domed sealing surface on the tubular coupling 100 designed to axially slide over a corresponding conical or domed surface on the pipe 200.

In fact, it is most preferable that, when the pipes 200 are screwed into the tubular coupling 100 in the made-up configuration, the first and second pipes 200 only contact the tubular coupling 100 by engagement of the threads (including the threads of the threaded zones).

One of the first and second pipes 200 is shown in FIG. 2. As mentioned above, the second pipe 200 is identical to the first pipe 200, so the figure could be of either of the first or second pipe 200.

The pipe 200 includes a male threaded zone 210 on its external surface. The male threaded zone 210 includes a trapezoidal male thread that tapers radially so as to reduce in diameter towards the terminal end of the pipe 200.

The entire male threaded zone 210 of the first pipe is arranged to engage the entire first female threaded zone 110a. Similarly, the entire male threaded zone 210 of the second pipe 200 is arranged to engage the entire second female threaded zone 110b.

As mentioned above, it is preferred that the male and female threads of the threaded zones 110a, 110b, 200 have trapezoidal thread forms. The preferred thread form for the first embodiment is shown in FIG. 4. The female threads comprise a crest 154, a root 151, a stabbing flank 153 and a load flank 152. The male threads comprise a crest 254, a root 251, a stabbing flank 253 and a load flank 252.

The male and female threads preferably have a constant axial width 403, 404 (i.e., the distance between the stabbing flank 153, 253 and load flank 152, 252).

The male and female threads preferably have a pitch of at most 5 turns per inch.

In the made-up configuration (and without being subject to external loads), when the threads are engaged, the load flanks 152, 252 of the male and female threads contact, the crests 154 of the female threads contact the roots 251 of the male thread, a clearance exists between the roots 151 of the female threads and the crests 254 of the male threads, and a clearance exists between the stabbing flanks 153, 253 of the male and female threads.

In the first embodiment, the crests 154, 254 and roots 151, 251 of the threads are parallel to the longitudinal axis of the respective member (the pipes 200 or the tubular coupling 100). This can assist in the stabbing process.

With reference to FIG. 4, a thread has a thread height 401, 402. The thread height 401, 402 is the same as the radial extent of the load flank 152, 252 (i.e., the distance in a direction perpendicular to the longitudinal axis of the member, whether it be tubular coupling or pipe).

In the case shown in FIG. 4, in which the crests 154, 254 and roots 151, 251 are parallel with the longitudinal axis, this is equivalent to the difference in radius between the crest 154, 254 and the root 151, 251 that is separated by the neighbouring load flank 152, 252 (as opposed to the root that is separated by the neighbouring stabbing flank 153, 253).

Preferably, the male threads have a thread height of no more than 2 mm. Also preferably, the female threads have a thread height of no more than 2 mm. Most preferably, the male and female threads have a thread height of from 0.7 mm to 1.6 mm.

Optionally, to assist the stabbing operation, a bevel is provided on the male and/or female threads where the crest 154, 254 meets the stabbing flank 153, 253.

As is known in the art, a notional pitch line 155, 255 may extend through the thread at an arbitrary (but constant for each turn) height. For example, a pitch line 155, 255 may extend through the mid-point of the load flank of each subsequent turn of the thread. The taper of a thread is the angle of that pitch line 155, 255 relative to the longitudinal axis of the respective member (pipe 200, or tubular coupling 100). Taper is defined in the conventional way. However, for the avoidance of doubt, a small taper means that the pitch line 155, 255 is almost parallel with the longitudinal axis (approximating a cylindrical surface), whereas a larger taper would be more flared.

In the first embodiment, the male and female threaded zones preferably have different tapers. The female threaded zone 110a, 110b has a first taper angle. The male threaded zone 210a, 210b of each pipe 200 has a second taper angle. The first angle is greater than the second angle.

As a result of this difference in angles, the threads in the first threaded zone 110a of the tubular coupling 100 and the threads in the threaded zone 210 of the first pipe 200 will tend to converge towards the terminal end of the first pipe.

Similarly, the threads in the second threaded zone 110b of the tubular coupling 100 and the threads in the threaded zone 210 of the second pipe 200 will tend to converge towards the terminal end of the second pipe 200.

Reference to the terminal end in the discussion above, of course, means the terminal end of the pipe 100 in the region of the coupling (that which is inserted into the tubular coupling, as opposed to the far end of the pipe not shown in the Figures).

The pipe 200 includes a shoulder surface 230 at its terminal end. The shoulder surface 230 is arranged for abutment with the shoulder surface 230 of another pipe 200.

The shoulder surface 230 is arranged for abutment with the shoulder surface 230 of another pipe 200. The shoulder surface 230 preferably lies on a plane extending perpendicular to the longitudinal axis of the pipe 200.

Preferably, the pipe 200 includes an unthreaded nose portion 220 leading from the male threaded zone 210 to the shoulder surface 230.

It is preferred that the shoulder 230 (and so the nose 220) has a radial thickness of at least 40% of the nominal wall thickness of the pipe body. This can assist in resisting the axial compression of the pipe end.

Optionally, the radially outer edge of the shoulder surface 230 at the ends of the pipes 200 includes a bevel 232. Bevelling the radially outer edge of the shoulder surface 230 at the ends of the pipes 200, can assist in the stabbing of the pipe 200 into the tubular coupling 100.

In the first embodiment, two pipes 200 may be screwed into a tubular coupling 100 so as to provide a threaded pipe connection in a made-up configuration in which the shoulders 230 of the first and second pipes 200 abut.

In the made up configuration, the entire male threaded zone 210 of the first pipe 200 engages the entire first female threaded zone 110a and the entire male threaded zone 210 of the second pipe 200 engages the entire second female threaded zone 110b.

In the made up configuration, the male and female threaded zones 110a, 110b, 210 engage so as to achieve radial interference. There is therefore a radial force between the tubular couplings 100 and the pipes 200. In the made up configuration, the shoulders 230 of the first and second pipe abut so as to achieve axial interference. The terminal ends of the pipes 200 (the pipe noses 220 in this embodiment) are therefore axially compressed.

The inventors have found that when the pipes 200 are subjected to such stresses, the terminal end of the pipes 200 can deform radially inwardly. This is shown in FIG. 3a, which corresponds to a connection similar to this first embodiment but without a reduction in interference in second portions 114a, 114b of the female threaded zones 110a, 110b (described below). As can be seen in FIG. 3a, as ITS increases (as depicted by each subsequent line on the graph in the direction of the arrow 300), the internal diameter of the abutment between the two shoulders 230 reduces. The figure therefore shows the deformation of the pipe noses 220 radially inwardly. As will be appreciated by the Skilled Person, ITS is the axial interference between the shoulder surfaces 203 as a result of torque applied. ITS correlates directly with torque applied starting with ITS=0 which corresponds to the torque required to get the shoulder surfaces to make initial contact.

The inventors have come up with a solution to this problem by reducing, or eliminating, the interference between the male and female threaded zones 110a, 110b, 210 around the location of pipe shoulder 230 abutment.

The first female threaded zone 110a is notionally divided into a first portion 112a and a second portion 114a, with the second portion 114a located at the inner end 115a of the first female threaded zone 110a. In the same way, the second female threaded zone 110b is notionally divided into a first portion 112b and a second portion 114b, with the second portion 114b located at the inner end 115b of the second female threaded zone 110b.

In the first embodiment, the female threads in each of the female threaded zones 110a, 110b are reduced in height in the second portions 114a, 114b as compared with the height of the thread in the first portions 112a, 112b. That is, the first portions 112a, 112b may be “complete” portions, and the second portions 114a, 114b may be “incomplete” portions. As a result, the interference between the crests 154 of the female threads and the roots 251 of the male threads is greater in the first portion 112a, 112b than in the second portion 114a, 114b. In fact, in some embodiments, there is no radial interference at all and there may even be a clearance in the second portion 114a, 114b.

The male threads in the male threaded zones 210a, 210b preferably have a constant height throughout so that the height of the male thread where it engages a first portion 112a, 112b is the same as the height of the male thread where it engages a second portion 114a, 114b.

Moreover, it is preferable that there be no interference between the crests 154 of the female threads and the roots 251 of the male threads in the second portions 114a, 114b. More preferably, there is a clearance between the crests 154 of the female threads and the roots 251 of the male threads in the second portions 114a, 114b.

As a result the hoop stresses in the tubular coupling 100 are not transferred to the same degree via the second portions 114a, 114b to the pipes 200 as they are via the first portions 112a, 112b. With reference to FIG. 3b, this can have a significant impact on the amount of deformation of the pipe noses 220 in the made-up configuration. As can be seen in FIG. 3b, as make-up torque increases (each subsequent line on the graph in the direction of the arrow 300), the internal diameter at the two shoulders 230 reduces by a much lesser amount than in FIG. 3a.

For ease of manufacture, the crest 154 of the female thread within each female threaded zone 110a, 110b may define a cylindrical surface at the inner end 115a, 115b of the female threaded zone 110a, 110b.

As mentioned above, the tubular coupling 100 preferably does not comprise any surfaces other than that of the thread to seal with the pipes 200. In such preferable embodiments, the clearance between the male and female threaded zones is preferably kept small to enable a thread seal to be effective. As discussed, the clearance between the engaged threads exists between the roots 151 of the female threads and the crests 254 of the male threads, and between the stabbing flanks 153, 253 of the male and female threads. The clearance is preferably no more than 0.18 mm between the first portion 112a, 112b of each female threaded zone 110a, 110b and the corresponding portion of the male threaded zone 210 engaged therewith.

It is preferred that the connection will be used with a lubricant such as dope to fill the clearance during make up.

A preferred method of manufacturing an embodiment of the threaded pipe connection of the first embodiment involves forming the tubular coupling by: providing a tubular body having an internal surface 101; cutting one or more threads into the internal surface to provide first and second tapered threaded zones 110a, 110b; and forming a cylindrical cut within the tubular body to reduce the height of the thread of an end portion of each the first and second tapered threaded zones 110a, 110b, that end portion being the end of each female threaded zone 110a, 110b nearest the middle (in an axial sense) of the tubular coupling 100. The end portions are at the adjacent axial ends of the female threaded zones.

When formed in this way, the crests 154 of the female thread within each female threaded zone 110a, 110b collectively define a common cylindrical surface at the inner end 115a, 115b of the female threaded zone 110a, 110b.

As will be appreciated, the first embodiment set out above has thread zones that provide reduced interference at the centre of the connection so as to reduce the deformation of the pipe ends under make-up torque. In the first embodiment, the female crest 154 engages the male root 251 and there is a clearance between the female root 151 and the male crest 254. As a result of this configuration, the reduced interference is achieved by reducing the height of the female thread (e.g., at crest 154). In fact, the invention is not limited to a connection in which the female crest 154 engages the male root 251 and there is a clearance between the female root 151 and the male crest 254. In a second embodiment, the male crest 254 engages the female root 151 and there is a clearance between the male root 251 and the female crest 154. In this configuration of the second embodiment, the same reduced interference is achieved at the middle of the connection. However, it is the male thread that is reduced in height at the middle of the connection (see crest 254). Other than this distinction, the remaining features are the same as the first embodiment.

That is, a second embodiment of a threaded pipe connection in accordance with the invention comprises: a tubular coupling 100 with first and second female threaded zones 110a, 110b formed in opposing halves of its internal surface; and first and second pipes 200, each comprising a male threaded zone 210 on its external surface and a shoulder surface 230 at its terminal end for abutment with the shoulder surface 230 of another pipe 200.

Each female threaded zone 110a, 110b includes a trapezoidal female thread that tapers radially within the female threaded zone 110a, 110b from a maximum diameter at the outer end 116a, 116b of the female threaded zone 110a, 110b.

Each male threaded zone 210 includes a trapezoidal male thread that tapers radially so as to reduce in diameter towards the terminal end of the pipe 230.

The threaded pipe connection is configured to enable the first and second pipes 200 to be engaged with the tubular coupling 100 in a made-up configuration in which: the shoulders 230 of the first and second pipes 200 abut; the entire male threaded zone 210 of the first pipe 200 engages the entire first female threaded zone 110a; and the entire male threaded zone 210 of the second pipe 200 engages the entire second female threaded zone 110b.

1. A threaded pipe connection comprising:
a tubular coupling with first and second female threaded zones formed in opposing sections; and
first and second pipes, each comprising a male threaded zone and a shoulder surface at its terminal end,
wherein each female threaded zone:
extends from an inner end to an outer end, wherein the inner end of each threaded zone is the end nearest a centre of the tubular coupling; and
includes a female thread that tapers radially within the female threaded zone from a maximum diameter at the outer end of the female threaded zone,
wherein each male threaded zone includes a male thread that tapers radially so as to reduce in diameter towards the terminal end of the pipe,
wherein the threaded pipe connection is configured to enable the first and second pipes to be engaged with the tubular coupling in a made-up configuration in which:
the shoulder surfaces of the first and second pipes abut;
the entire male threaded zone of the first pipe engages the entire first female threaded zone;
the entire male threaded zone of the second pipe engages the entire second female threaded zone; and
for each of the first and second female threaded zones:
a crest of one of the male and female threads radially interferes with a root of the other of the male and female threads in a first portion of the female threaded zone and does not interfere or interferes by a smaller amount in a second portion of the female threaded zone; and
the second portion is located at the inner end of the female threaded zone.

2. The threaded pipe connection of claim 1, wherein in the made-up configuration in each of the first and second female threaded zones the crest of the one of the male and female threads is free from radial interference with the root of the other of the male and female threads in the second portion of the female threaded zone.

3. The threaded pipe connection of claim 1, wherein in the second portion:
there is no interference and, optionally, a clearance between the root of the male thread and the crest of the female thread; and/or
there is no interference and, optionally, a clearance between the crest of the male thread and the root of the female thread.

4. The threaded pipe connection of claim 1, wherein in the made-up configuration in each of the first and second female threaded zones there is a clearance between the root of the one of the male and female threads and the crest of the other of the male and female threads.

5. The threaded pipe connection of claim 4, wherein an axial length of the second portion of the female threaded zone is at least 4 turns, or wherein the axial length of the second portion of the female threaded zone is at least 20 mm.

6. The threaded pipe connection of claim 1, wherein:
the first portion is a complete portion in which a height of the female thread is constant; and
the second portion is an incomplete portion in which the height of the female thread is less than in the complete portion.

7. The threaded pipe connection of claim 6, wherein the crest of the female thread throughout the complete portion of the female threaded zone is arranged to contact the root of the male thread of a male threaded zone.

8. The threaded pipe connection of claim 6, wherein the crest of the female thread within the second portion of each female threaded zone defines a cylindrical surface.

9. The threaded pipe connection of claim 1, wherein the crests of the female threads of the second portions of both female threaded zones define a common cylindrical surface.

10. The threaded pipe connection of claim 1, wherein the tubular coupling does not comprise a shoulder surface between the first and second female threaded zones.

11. The threaded pipe connection of claim 1, wherein in the made-up configuration the first and second pipes are free from contact with the tubular coupling between the male threaded zones of the first and second pipes.

12. The threaded pipe connection of claim 1, wherein in the made-up configuration the first and second pipes only contact the tubular coupling via threaded engagement.

13. The threaded pipe connection of claim 1, wherein:
the female thread tapers within the female threaded zone by a first angle relative to a longitudinal axis of the tubular coupling;
each male thread tapers radially within the male threaded zone by a second angle relative to the longitudinal axis of the respective pipe; and
the first angle is greater than the second angle such that the tapers converge toward the terminal end of each pipes.

14. The threaded pipe connection of claim 1, wherein the male threads have a thread height of no more than 2 mm.

15. The threaded pipe connection of claim 1, wherein the shoulder has a radial thickness of at least 40% of the nominal wall thickness of the pipe body.

16. The threaded pipe connection of claim 1, wherein the female threads have a thread height of no more than 2 mm.

17. The threaded pipe connection of claim 1, wherein the crests and roots of the male threads are parallel to a longitudinal axis of the pipes, and the crests and roots of the female threads are parallel to the longitudinal axis of the tubular coupling.

18. The threaded pipe connection of claim 1, wherein the radially outer edge of the shoulder surface at the ends of the pipes is bevelled.

19. The threaded pipe connection of claim 1, wherein a bevel is provided on the male and/or female threads where the crest meets a stabbing flank.

20. A method of manufacturing a tubular coupling for a threaded pipe connection, comprising:
providing a tubular coupling having first and second tapered threaded zones with adjacent inner end portions, wherein each tapered threaded zone extends from the inner end to an outer end, wherein the inner end of each threaded zone is the end nearest a centre of the tubular coupling; and
reducing a height of the threads of the adjacent inner end portions of each the first and second tapered threaded zones.

21. The method of claim 20, further comprising the step of cutting one or more threads into an internal surface of a tubular body to provide first and second tapered threaded zones.

22. The method of claim 20, wherein reducing the height of the threads of adjacent end portions of each of the first and second tapered threaded zones comprises cutting a cylindrical surface within a tubular body to reduce the height of the threads of adjacent end portions of each the first and second tapered threaded zones.

23. The method of claim 20, further comprising engaging first and second pipes with the tubular coupling to thereby provide the threaded pipe connection.
